(19) United States
(12) Patent Application Publication
(10) Pub. No.: US 2026/0017843 A1
(43) Pub. Date: Jan. 15, 2026

(54) VIDEO GENERATION DEVICE, VIDEO GENERATION METHOD, AND VIDEO GENERATION PROGRAM

(71) Applicant: NIPPON TELEGRAPH AND TELEPHONE CORPORATION, Tokyo (JP)

(72) Inventors: Motohiro MAKIGUCHI, Tokyo (JP); Masanori YOKOYAMA, Tokyo (JP); Masahiro KOJIMA, Tokyo (JP); Wakana OSHIRO, Tokyo (JP); Ryuji YAMAMOTO, Tokyo (JP)

(73) Assignee: NIPPON TELEGRAPH AND TELEPHONE CORPORATION, Tokyo (JP)

(21) Appl. No.: 18/995,914

(22) PCT Filed: Jul. 28, 2022
(86) PCT No.: PCT/JP2022/029176

§ 371 Date: Jan. 17, 2025

(51) Int. Cl. G06T 11/00

(52) U.S. Cl. CPC G06T 11/00

(57) ABSTRACT

The video generation device includes an audience video acquisition unit, a content video acquisition unit, a motion acquisition unit, a video generation unit, and a video output unit. The audience video acquisition unit acquires an audience seat video frame of a local audience in a venue of an event. The content video acquisition unit acquires a content video frame of the event. The motion acquisition unit acquires action information of a remote audience who views the event remotely. The video generation unit generates a virtual audience video frame based on an audience seat video frame and action information of the remote audience, combines the content video frame with the virtual audience video frame, and generates a viewing video of the remote audience. The video output unit outputs the viewing video to a display device under a viewing environment of the remote audience.

### TECHNICAL FIELD

The present invention relates to a video generation device, a video generation method, and a video generation program.

### BACKGROUND ART

In a remote viewing service for remotely viewing an event such as a live music show or a sport, displaying a group of audience members other than oneself is an important factor in reproducing an emotional experience such as a sense of unity or excitement felt at the time of viewing at a local venue.

As a method of displaying an audience group in an existing remote viewing service, a strategy such as including a video of audience seats in a distribution video is devised. However, when the video of the audience seats is distributed as it is, consideration for privacy such as prevention of showing of the faces of the audience becomes a problem.

As a method for coping with this, virtualization of the audience group such as a method of capturing the motion of the user by motion capture and expressing the motion on an avatar in the virtual space (Non Patent Literature 1), a method of artificially applying the motion of the audience to a built-in avatar, and a method of expressing the audience with a physical penlight (Non Patent Literature 2) is conceivable.

### CITATION LIST

### Non Patent Literature

Non Patent Literature 1: Tatsuyoshi KANEKO, Hiroyuki TARUMI, Yuki KUBOCHI, Ryota YAMAGUCHI, Keiya KATAOKA, Daiki YAMASHITA, Tomoki NAKAI, “Supporting the Sense of Unity between Remote Audiences in VR-Based Remote Live Music Support System KSA2”, 2018 IEEE International Conference on Artificial Intelligence and Virtual Reality (AIVR) Non Patent Literature 2: Masaki NAKA, Mio AYABE, Ren UEDA, and Motofumi SHIKIDA: A supporting method for interactive communication by visualizing excitement with penlights at the livestream concerts without audience, Research report of Information Processing Society of Japan, Vol. 2022-GN-115, No. 39, pp. 1-7, 2022

### SUMMARY OF INVENTION

### Technical Problem

Interaction between audience members is important to obtain a sense of unity similar to that in a local venue. In the current remote viewing service, only one-way distribution of the video is performed, and the video in which the action of the remote audience is reflected on the virtual audience is not distributed.

An object of the present invention is to provide a video generation device, a video generation method, and a video generation program for generating a viewing video including a virtual audience video reflecting an action of a remote audience.

### Solution to Problem

One aspect of the present invention is a video generation device. The video generation device includes an audience video acquisition unit, a content video acquisition unit, a motion acquisition unit, a video generation unit, and a video output unit. The audience video acquisition unit acquires an audience seat video frame of a local audience in a venue of an event. The content video acquisition unit acquires a content video frame of the event. The motion acquisition unit acquires action information of a remote audience who views the event remotely. The video generation unit generates a virtual audience video frame based on an audience seat video frame and action information of the remote audience, combines the content video frame with the virtual audience video frame, and generates a viewing video of the remote audience. The video output unit outputs the viewing video to a display device under a viewing environment of the remote audience.

One aspect of the present invention is a video generation method. A video generation method includes acquiring an audience seat video frame of a local audience in a venue of an event, acquiring a content video frame of the event, acquiring action information of a remote audience who views the event remotely, generating a virtual audience video frame based on the audience seat video frame and the action information of the remote audience, combining the content video frame with the virtual audience video frame, and generating a viewing video of the remote audience, and outputting the viewing video to a display device under a viewing environment of the remote audience.

One aspect of the present invention is a video generation program. The video generation program causes a processor included in a computer to execute a function of each component of the video generation device.

### Advantageous Effects of Invention

According to the present invention, a video generation device, a video generation method, and a video generation program for generating a viewing video including a virtual audience video reflecting an action of a remote audience are provided.

### BRIEF DESCRIPTION OF DRAWINGS

FIG. 1 is a block diagram illustrating an example of a functional configuration of a video generation device according to an embodiment.

FIG. 2 is a block diagram illustrating an example of a hardware configuration of the video generation device according to the embodiment.

FIG. 3 is a flowchart illustrating an example of a processing procedure and processing content of video generation executed by the video generation device according to the embodiment.

FIG. 4 is a diagram for illustrating processing executed by a video generation unit of the video generation device according to the embodiment.

### DESCRIPTION OF EMBODIMENTS

Hereinafter, an embodiment of the present invention will be described with reference to the drawings.

### [Functional Configuration]

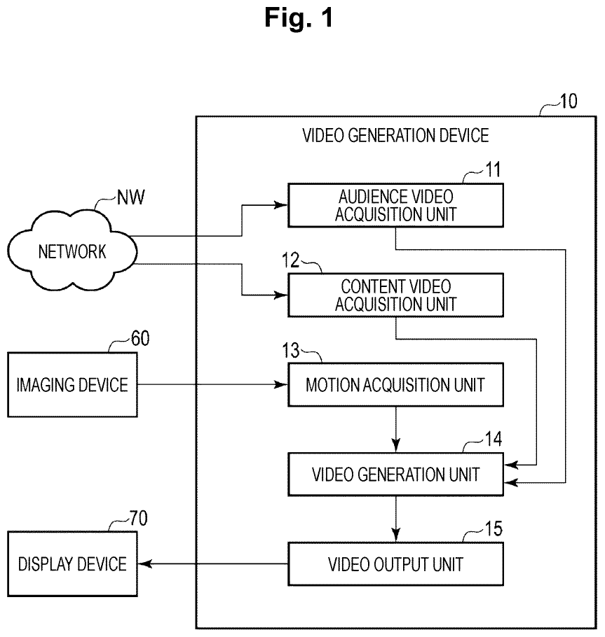

A video generation device 10 according to an embodiment of the present invention will be described with reference to FIG. 1. FIG. 1 is a block diagram illustrating a functional configuration of the video generation device 10 according to an embodiment of the present invention. The video generation device 10 is a device that generates a viewing video to be provided to a remote audience who remotely views an event such as a live music show or a sport.

As illustrated in FIG. 1, the video generation device 10 according to an embodiment of the present invention includes an audience video acquisition unit 11, a content video acquisition unit 12, a motion acquisition unit 13, a video generation unit 14, and a video output unit 15.

The audience video acquisition unit 11 acquires a video of a local audience in a venue of an event via a network NW. The audience video acquisition unit 11 acquires local audience information based on the video of the local audience. The audience video acquisition unit 11 acquires an audience seat video frame based on the local audience information. The audience video acquisition unit 11 outputs the audience seat video frame to the video generation unit 14.

The content video acquisition unit 12 acquires the video of the event via the network NW. The content video acquisition unit 12 acquires the content video frame based on the video of the event. The content video frame is a video frame that does not include a local audience. For example, if the event is a live music show, the content video frame is a video frame of an artist, and if the event is a sport, the content video frame is a video frame of a sports scene. Hereinafter, for convenience, description will be made assuming that the event is a live music show. The content video acquisition unit 12 outputs the content video frame to the video generation unit 14.

The motion acquisition unit 13 acquires a video of a remote audience from an imaging device 60. The remote audience is a user who receives the provision of the remote viewing service. In other words, the user is a user of a remote viewing service who remotely views an event. The imaging device 60 is installed near a remote audience. The imaging device 60 is generally a camera. The remote audience operates the imaging device 60 to image the remote audience itself. The motion acquisition unit 13 acquires the action information of the remote audience based on the video of the remote audience. The motion acquisition unit 13 outputs the action information of the remote audience to the video generation unit 14.

The action information of the remote audience is, for example, a penlight swing or a penlight color (and color change). Here, the description will be given assuming that the action information of the remote audience is the color of penlights. However, the action information of the remote audience is not limited thereto, and may be information such as other motions.

The video generation unit 14 generates a virtual audience video frame based on the audience seat video frame received from the audience video acquisition unit 11 and the action information of the remote audience received from the motion acquisition unit 13. The virtual audience video frame is a video frame obtained by virtualizing an action of a remote audience and a local audience having a high degree of similarity of the action. The video generation unit 14 combines the content video frame received from the content video acquisition unit 12 with the virtual audience video frame to generate a viewing video frame of the remote audience. The video generation unit 14 outputs the viewing video frame to the video output unit 15.

The video output unit 15 outputs the viewing video received from the video generation unit 14 to a display device 70. The display device 70 is under a viewing environment of a remote audience. That is, the display device 70 is installed near the remote audience. The display device 70 is, for example, a monitor or a head mounted display (HMD). The remote audience views the viewing video frame through the display device 70.

### [Hardware Configuration]

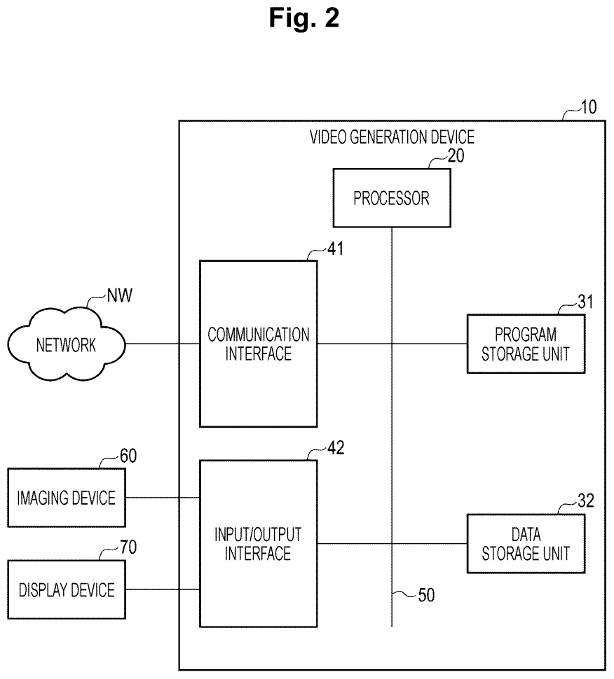

Next, a hardware configuration of the video generation device 10 according to an embodiment of the present invention will be described with reference to FIG. 2. FIG. 2 is a block diagram illustrating a hardware configuration of the video generation device 10 according to an embodiment of the present invention.

The video generation device 10 includes a computer. For example, the video generation device 10 includes a personal computer. Here, an example in which the video generation device 10 is configured by a personal computer that can be operated by a remote audience will be described. However, the present invention is not limited thereto, and the video generation device 10 may be configured by, for example, a server computer or the like.

As illustrated in FIG. 2, the video generation device 10 includes a hardware processor 20, a program storage unit 31, a data storage unit 32, a communication interface 41, and an input/output interface 42. The hardware processor 20, the program storage unit 31, the data storage unit 32, the communication interface 41, and the input/output interface 42 are connected to each other via a bus 50, and can exchange information with each other.

The hardware processor 20 is, for example, a central processing unit (CPU). The hardware processor 20 executes a program, performs arithmetic processing of data, and the like. The hardware processor 20 controls the program storage unit 31, the data storage unit 32, the communication interface 41, and the input/output interface 42. The hardware processor 20 further controls the imaging device 60 and the display device 70 connected to the input/output interface 42 as will be described later.

The program storage unit 31 is configured by combining, for example, a non-volatile memory capable of writing and reading at any time such as a hard disk drive (HDD) or a solid state drive (SSD) and a non-volatile memory such as a read only memory (ROM), as a non-transitory tangible storage medium. The program storage unit 31 stores a program to be executed by the hardware processor 20 in order for the video generation device 10 to execute each type of processing.

The data storage unit 32 is configured by combining, for example, the above-described non-volatile memory and a volatile memory such as a random access memory (RAN), as a tangible storage medium. The data storage unit 32 temporarily stores data necessary for processing executed by the hardware processor 20.

The communication interface 41 includes, for example, a wireless communication interface unit and enables transmission and reception of information between the hardware processor 20 and the like and a communication network NW. A wireless interface can be, for example, an interface adopting a low-power wireless data communication standard, such as a wireless local area network (LAN).

The input/output interface 42 is connected to the imaging device 60 and the display device 70. The input/output interface 42 enables transmission and reception of information between the hardware processor 20 and the like, and the imaging device 60 and the display device 70.

In such a hardware configuration, the functions of the respective units of the video generation device 10, that is, the audience video acquisition unit 11, the content video acquisition unit 12, the motion acquisition unit 13, the video generation unit 14, and the video output unit 15, can be implemented by the hardware processor 20 reading and executing the program stored in the program storage unit 31 in cooperation with the data storage unit 32.

Some or all of the units of the video generation device 10 may be configured in various other formats including an integrated circuit such as an application specific integrated circuit (ASIC) or a field-programmable gate array (FPGA).

### [Operation Example]

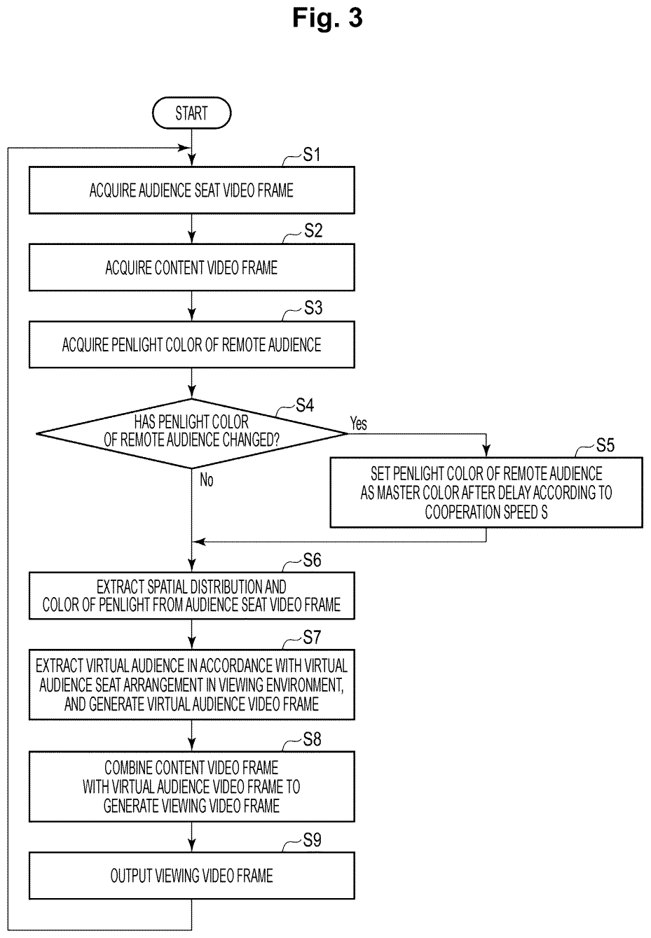

Next, an example of video generation processing executed by the video generation device 10 will be described with reference to FIG. 3. FIG. 3 is a flowchart illustrating a processing procedure and processing content of video generation executed by the video generation device 10 according to the embodiment.

Here, an example of the following video generation processing will be described. The remote audience is watching the video of the event venue, for example, the live video, remotely. Both the local audience and the remote audience in the event venue shake the penlight in accordance with the live show, and change the color of the penlight as appropriate. The color of the penlight of the remote audience is captured as an action of the remote audience. A virtual audience video is generated by virtualizing a local audience having many penlights of the same color as the color of the penlights of the remote audience. A video obtained by synthesizing a content video not including a local audience with a virtual audience video is provided to a remote audience as a viewing video.

Furthermore, as a preset, the video generation unit 14 stores a preset parameter for generating the virtual audience video. For example, the preset parameter includes a viewing environment of the remote audience, a cooperation speed S and a cooperation probability P of the remote audience. The viewing environment of the remote audience includes a virtual audience seat arrangement and the number of virtual audiences. The preset parameter is not limited thereto, and may include other information.

In step S1, the audience video acquisition unit 11 acquires videos of local audiences in an event venue via a network NW. The audience video acquisition unit 11 acquires local audience information based on the video of the local audience. The audience video acquisition unit 11 acquires an audience seat video frame based on the local audience information.

In step S2, the content video acquisition unit 12 acquires the live video of the event venue via the network NW. The content video acquisition unit 12 acquires the content video frame based on the live video.

In step S3, the motion acquisition unit 13 acquires a video of a remote audience from the imaging device 60. The motion acquisition unit 13 acquires the action information of the remote audience based on the video of the remote audience. Here, the motion acquisition unit 13 acquires the color of the penlight of the remote audience.

In step S4, the video generation unit 14 determines whether the color of the penlight of the remote audience has changed. For example, the video generation unit 14 compares the previous action information (the color of the penlight) received from the motion acquisition unit 13 with the current action information (the color of the penlight), and determines whether the color of the penlight has changed.

In a case where the video generation unit 14 determines that the color of the penlight has changed, the processing proceeds to step S5, and in a case where the video generation unit determines that the color of the penlight has not changed, the processing proceeds to step S6.

In step S5, the video generation unit 14 sets the color of the penlight of the remote audience as the master color after the delay according to the cooperation speed S.

In step S6, the video generation unit 14 extracts the spatial distribution and the color of the penlight from the audience seat video frame acquired in step S1.

Specifically, the video generation unit 14 extracts the spatial distribution and color of the penlight as follows.

S6a: The audience seat video frame is converted to grayscale, and the portions with a certain brightness and size are extracted as the illuminated portions of the penlights. The center coordinates of the extracted image of the penlight lighting portion are listed as penlight position coordinates.

S6b: For each penlight lighting portion extracted in S6a, the color of the penlight is estimated with reference to the pixel value of the color image and added to the list.

S6c: For the audience seat video frame, the audience seat range is designated based on the virtual audience seat arrangement in the viewing environment of the remote audience set in advance. A homography transformation is performed on the audience seat video frame in the audience seat range, and the penlight position coordinates obtained in S6a are mapped on the audience seat video frame without distortion.

In step S7, the video generation unit 14 extracts the virtual audience from the audience seat video frame in accordance with the virtual audience seat arrangement in the viewing environment of the remote audience, and generates the virtual audience video frame.

Specifically, the video generation unit 14 extracts the virtual audience and generates the virtual audience video frame as follows.

S7a: The audience seat video frames of the local audiences in the event venue extracted in step S6 are associated with the virtual audience seat arrangements matched with the viewing audiences of the remote audiences, and a plurality of aggregation areas are set in the audience seat video frames of the local audiences in the event venue.

S7b: For each aggregation area, an action of a local audience in the aggregation area, that is, a color of a penlight, is counted. In a case where the action of the local audience, that is, the color of the penlight, in the aggregation area includes the master color, that is, the color of the penlight of the remote audience, the master color is set as the representative color of the aggregation area with the cooperation probability P. In other words, the action of the local audience in the aggregation area, that is, the color of the penlight, is aggregated to the master color, that is, the color of the penlight of the remote audience, with the cooperation probability P. On the other hand, in a case where the color of the penlight in the aggregation area does not include the master color, the action of the local audience in the aggregation area, that is, the color of the penlight is set as the representative color of the aggregation area, the most common color among them. The actions of the local audiences in the aggregation area, that is, the color of the penlights, are aggregated into the color of the most actions, that is, the penlights among them.

S7c: The penlight of the representative color obtained in S7b is arranged in each aggregation area in the audience seat video frame to generate a virtual audience video frame.

In step S8, the video generation unit 14 combines the content video frame acquired in step S2 with the virtual audience video frame generated in step S7 to generate a viewing video frame of the remote audience.

In step S9, the video output unit 15 outputs the viewing video frame generated in step S8 to the display device 70 under the viewing environment of the remote audience.

The video generation device 10 repeats a series of processing in steps S1 to S9 described above.

### [Generation Example of Virtual Audience Video Frame]

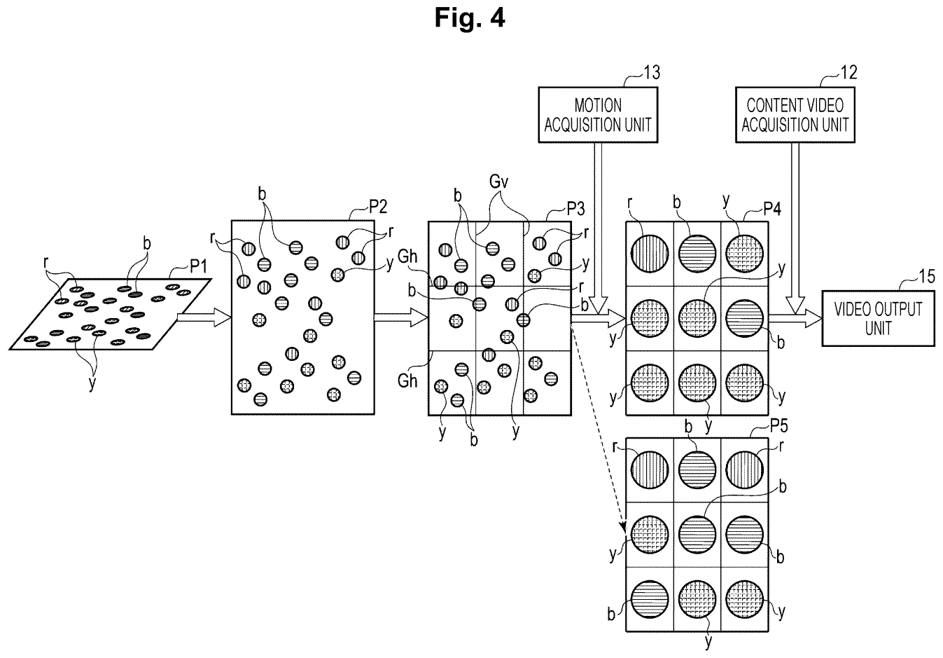

Next, with reference to FIG. 4, processing executed by the video generation unit 14 will be described, particularly focusing on generation of the virtual audience video frame. FIG. 4 is a diagram for illustrating processing executed by the video generation unit 14 of the video generation device 10 according to the embodiment.

The video generation unit 14 designates the audience seat range for an audience seat video frame P1 captured from the bird's eye. Next, the video generation unit 14 converts the bird's-eye view image of the audience seat range into an audience seat video frame P2 of a top view of the audience seat range by homography transformation.

Subsequently, the video generation unit 14 acquires the action, that is, the distribution of the color of the penlight, from the audience seat video frame P2 in the top view of the audience seat range. Here, a circle r represents a red penlight, a circle b represents a blue penlight, and a circle y represents a yellow penlight.

Next, the video generation unit 14 sets an aggregation area corresponding to the virtual audience seat arrangement in the viewing environment of the remote audience for the audience seat video frame P2 of the top view of the audience seat range from which the color distribution of the penlights has been acquired. Here, as an example, nine quadrangular aggregation areas are set by two vertical grids Gv and two horizontal grids Gh.

Subsequently, the video generation unit 14 integrates the actions of the local audiences in the aggregation area, that is, the colors of the penlights possessed by the local audiences, in consideration of the action information of the remote audiences, that is, the colors of the penlights, received from the motion acquisition unit 13, with respect to each aggregation area of the audience seat video frame P3, and creates the virtual audience video frame P4. Here, an example is illustrated in which the color of the penlight of the remote audience is yellow.

The color aggregation of the penlights in each aggregation area is performed as follows. In a case where penlights having the same color as the color of the penlights of the remote audience are included in each aggregation area, aggregation is performed to the color of the penlights of the remote audience with the cooperation probability P. In a case where penlights of the same color as that of the penlights of the remote audience are included in each aggregation area when the penlights are not included, the penlights are aggregated into the color of the penlights with the most common color of penlight.

P5 represents a virtual audience video created by simply aggregating the colors of penlights according to a majority decision as a comparative example. When the virtual audience video frame P4 and the virtual audience video frame P5 are compared with each other, in the virtual audience video frame P4, the aggregation areas of the upper right, the center, and the lower left are aggregated into the same yellow color as the color of the penlight of the remote audience, whereas in the virtual audience video frame P5, the aggregation areas of the upper right, the center, and the lower left are aggregated into colors different from the color of the penlight of the remote audience, that is, red, blue, and blue, respectively.

As described above, the virtual audience video frame P4 formed by the video generation unit 14 is a video having cooperative property with the action of the remote audience, that is, the color of the penlight.

Finally, the video generation unit 14 combines the content video frame received from the content video acquisition unit 12 with the virtual audience video frame P4 created as described above, and outputs the combined video frame to the video output unit 15.

### [Effects]

According to the embodiment, many virtual audience videos having penlights of the same color as the penlights of the remote audience are projected on the viewing video of the remote audience displayed on the display device 70. As a result, an interaction in which the remote audience and the virtual audience video cooperate with each other is realized. As a result, the remote audience can enjoy a sense of unity with the local audience in the event venue and a sense of excitement similar to the local audience.

In the embodiment, an example in which cooperativity with an action of a remote audience is emphasized has been described. However, the attribute of the remote audience is acquired in advance, and in a case where it is determined from the attribute that the remote audience does not like cooperation, the cooperation probability P may be lowered. Furthermore, the color of the aggregation area may be changed to the color of the penlight of the remote audience. For example, the color of the aggregation area may be changed to the color of penlight that is the second most in the aggregation area.

Furthermore, in the embodiment, an example has been described in which the action information of the remote audience is the color of the penlight of the remote audience. However, the action information of the remote audience is not limited thereto at all. For example, the action information of the remote audience may be a penlight swing phase (penlight angle), a penlight swing direction (shake vertically, shake horizontally), a penlight swing position (shake above head, shake below foot), a penlight swing motion (swinging so as to draw a circle), and the like.

Note that the present invention is not limited to the above embodiments, and various modifications can be made in the implementation stage without departing from the gist of the invention. In addition, the embodiments may be implemented in appropriate combination, and in this case, a combined effect can be obtained. Furthermore, the above embodiment includes various inventions, and various inventions can be extracted by a combination selected from a plurality of disclosed components. For example, even if some components are deleted from all the components described in the embodiment, a configuration from which the components have been deleted can be extracted as an invention, as long as the problem can be solved and the effects can be achieved.

### REFERENCE SIGNS LIST

10 Video generation device
11 Audience video acquisition unit
12 Content video acquisition unit
13 Motion acquisition unit
14 Video generation unit
14 Video output unit
20 Hardware processor
31 Program storage unit
32 Data storage unit
41 Communication interface
42 Input/output interface
50 Bus
60 Imaging device
70 Display device

1. A video generation device comprising:
audience video acquisition circuitry that acquires an audience seat video frame of a local audience in a venue of an event;
content video acquisition circuitry that acquires a content video frame of the event;
motion acquisition circuitry that acquires action information of a remote audience who views the event remotely;
video generation circuitry that generates a virtual audience video frame based on the audience seat video frame and the action information of the remote audience, combines the content video frame with the virtual audience video frame, and generates a viewing video of the remote audience; and
video output circuitry that outputs the viewing video to a display device under a viewing environment of the remote audience.

2. The video generation device according to claim 1, wherein:
the video generation circuitry generates the virtual audience video frame including an action of the remote audience and the local audience having a high degree of similarity of the action based on the action information.

3. The video generation device according to claim 2, wherein the video generation circuitry:
designates an audience seat range for the audience seat video frame based on a virtual audience seat arrangement in a viewing environment of the remote audience, and
extracts a virtual audience from the audience seat video frame in accordance with the virtual audience seat arrangement in the viewing environment of the remote audience, and generates the virtual audience video frame.

4. The video generation device according to claim 3, wherein:
the video generation circuitry sets a plurality of aggregation areas in the audience seat video frames in the audience seat range, and aggregates actions of the local audience in each aggregation area in consideration of the action information of the remote audience for each aggregation area.

5. The video generation device according to claim 4, wherein:
in a case where the action of the local audience in each aggregation area includes the action of the remote audience, the video generation circuitry aggregates the action of the local audience in the aggregation area into the action of the remote audience with a cooperation probability P.

6. The video generation device according to claim 5, wherein:
in a case where the action of the remote audience is not included in the action of the local audience in each aggregation area, the video generation circuitry aggregates the action of the local audience in the aggregation area into the largest number of actions.

7. A video generation method, comprising:
acquiring an audience seat video frame of a local audience in a venue of an event;
acquiring a content video frame of the event;
acquiring action information of a remote audience who views the event remotely;
generating a virtual audience video frame based on the audience seat video frame and the action information of the remote audience, combining the content video frame with the virtual audience video frame, and generating a viewing video of the remote audience; and
outputting the viewing video to a display device under a viewing environment of the remote audience.

8. A non-transitory computer readable medium storing a video generation program for causing a processor to perform the method of claim 7.
